(19) United States
(12) Patent Application Publication
(10) Pub. No.: US 2022/0379929 A1
(43) Pub. Date: Dec. 1, 2022

(54) Cable Transport With Transport Vehicle For Conveying An Object

(71) Applicant: Innova Patent GmbH, Wolfurt (AT)

(72) Inventors: Florian Trittler, Sulz (AT); Martin Schönenberger, Diepoldsau (CH)

(21) Appl. No.: 17/755,941

(22) PCT Filed: Nov. 11, 2020
(86) PCT No.: PCT/EP2020/081688

§ 371 Date: May 12, 2022

(30) Foreign Application Priority Data
Nov. 12, 2019 (AT) A50968/2019

(51) Int. Cl. B61B 12/00; B61B 12/02; B62H 3/04; B62H 3/12

(52) U.S. Cl. CPC B61B 12/002; B61B 12/024; B62H 3/04; B62H 3/12

(57) ABSTRACT

To simplify the transport of objects with a transport vehicle of a cableway and the loading and unloading of objects, in particular bicycles or other sports or leisure equipment, it is provided that a vehicle component of a drive gear mechanism is rotatably mounted on the transport vehicle, and a station component is arranged in at least one cableway station and interacts at least temporarily with the vehicle component to form a drive gear mechanism when the transport vehicle passes through the cableway station in a direction of conveyance. A receiving part having a plurality of receiving devices for releasably receiving the object is arranged on the transport vehicle, and the receiving part is movable relative to the transport vehicle, and the movement thereof is driven by the vehicle component of the drive gear mechanism.

### TECHNICAL FIELD

The present teaching relates to a cableway station through which a transport vehicle can be moved to receive an object to be conveyed, wherein a receiving part having a plurality of receiving devices for releasably receiving an object is arranged on the transport vehicle, wherein the receiving part is movable relative to the transport vehicle. The present teaching also relates to a cableway having such a cableway station.

### BACKGROUND

Cableway systems are used to transport people and materials between two or more cableway stations. For this purpose, a plurality of cableway vehicles, such as chairs or cable cars, is moved between the cableway stations, either circulating or traveling back and forth. The cableway vehicles are moved between the cableway stations by means of at least one haul rope. The cableway vehicle can be suspended from at least one haul rope (in the case of an aerial cableway), or can be arranged on rails or on the ground (funicular railways) in a manner allowing movement, and can be moved with at least one haul rope. However, the cableway vehicle can also be releasably or fixed clamped to the haul rope, and moved with the haul rope. In the case of circulating cableways, the cableway vehicles are often decoupled from the traction cable in a cableway station, for example by means of releasable cable clamps, and are moved through the cableway station at a lower speed, in order to make it easier for people to get on or off, or to make it easier to load or unload material.

A known practice is that of actuating certain functions of cableways, for example, opening or closing a cable clamp, raising, or lowering a safety bar or a weather protection hood of a chair, or opening and closing a door of a cable car or gondola in a cableway station—via guide mechanisms. For this purpose, a motion link is fixed to the station, and a contact element on the cableway vehicle contacts the motion link when it passes through the station. The contact element is arranged on a rotatably mounted lever, which is pivoted upon the contact. The specific function is then carried out via a Bowden cable connected to the lever or a leverage. An example of the opening and closing function of a door can be found in U.S. Pat. No. 3,742,864 A, and EP 1 671 867 B1 shows an example of a safety bar being raised and lowered.

A further known practice is that of attaching objects, for example skis, snowboards, or bicycles, to the cableway vehicle, and transporting them with the cableway vehicle. An example of this can be found in WO 2017/001224 A1 or FR 2 692 217 B1. A further known practice is that of providing separate transport vehicles for objects, such as bicycles, on the cableway, in addition to cableway vehicles for transporting people. An example of this can be found in WO 2016/164941 A1. However, the difficulty in this case is often that modern cableway systems have a high transport capacity, and many people, often 4 to 15 people, are transported with one cableway vehicle. The result is often that a crowd forms during the loading and unloading of the cableway vehicle with objects, such as skis, snowboards, or bicycles from the. Apart from that, cable cars as cableway vehicles are only suitable for transporting bicycles to a limited extent, because only a few people, in particular significantly fewer than there would be room for, can be transported with their bicycles in a cable car. Apart from that, when bicycles are transported in a cable car, the cable car can become soiled, which in turn makes a tedious cleaning of the cable cars necessary. It is also known that bicycles are attached to the outside of the cable car, for example on special brackets on the door. The disadvantage in this case is that only a few, usually a maximum of two, bicycles can be transported at the same time. In an embodiment according to WO 2017/001224 A1, in which the bicycles are attached to the back of a chair, the bicycles must first be attached to the back, and only then can the passengers take their place on the chair. Therefore, the chairs can only be moved relatively slowly through the station.

AT 521 785 A4 discloses a transport vehicle having a support element for holding bicycles. The support element is rotatable relative to the transport vehicle. The support element can be rotated automatically and/or manually via a drive, for example an electric motor or a mechanism. However, the design of such a drive is not specified in detail.

### SUMMARY

It is an object of the present teaching to specify a cableway that facilitates the transport of objects with a cableway and facilitates the loading and unloading of objects, in particular bicycles or other sports or leisure equipment.

According to the present teaching, this object is achieved in that a vehicle component is rotatably mounted on the transport vehicle, and the vehicle component drives the movement of the receiving part, and a station component is arranged on the cableway station, which station component is designed to form a drive gear mechanism for interacting with the vehicle component rotatably mounted on the transport vehicle, wherein the station component extends through the cableway station in the direction of conveyance of the transport vehicle at least in sections along the cableway station. The vehicle component and the station component interact in the cableway station when the transport vehicle passes through the cableway station, and form a drive with which a receiving part on the transport vehicle, with receiving devices for the object to be transported, can be moved. The movement of the transport vehicle when the transport vehicle passes through the cableway station is thus used to rotate the receiving part.

In a preferred, structurally simple embodiment, the receiving part is arranged so that it can rotate relative to the transport vehicle. This also enables the receiving part in the cableway station to be rotated at least once completely by the drive, such that each receiving device on the receiving part is accessible at least once in the cableway station. For this purpose, the receiving part can be embodied in a structurally simple manner as a column mounted rotatably on the transport vehicle.

The movement of the receiving part on the transport vehicle can advantageously be influenced if a transmission part with at least one transmission ratio stage is provided between the vehicle component and the receiving part, in order to establish a transmission ratio between the rotational movement of the vehicle component and the movement of the receiving part. In an advantageous embodiment, the transmission part is designed with a first transmission ratio stage which comprises a gear mechanism, and a second transmission ratio stage which comprises a traction drive or chain drive.

The drive is advantageously designed with a non-positive drive gear mechanism or a positive drive gear mechanism. Accordingly, the vehicle component is designed as a gear wheel or as a friction wheel. The station component is designed to correspond to the vehicle component, for example as a friction surface for a non-positive drive gear mechanism, or as a toothed rack, a chain, or with pins for a positive drive gear mechanism.

A platform is advantageously provided in the cableway station, wherein the station component is arranged opposite the platform, such that the transport vehicle can be moved between the platform and the station component. This enables easy and safe access to the receiving part from the platform.

In order to create different areas in the cableway station for loading/unloading the receiving part, at least one area with a station component and an adjoining area without a station component can be provided along the cableway station. Several consecutive areas with and without station components can also be provided along the cableway station.

A structurally very simple design results when the station component is arranged in a stationary manner on the cableway station. If the station component is movably arranged on the cableway station, preferably movable in the direction of conveyance of the transport vehicle, the relative speed between the station component and the vehicle component, and thus also the movement of the receiving part, can be influenced.

If the drive is designed so that the direction of movement of the receiving part is oriented opposite the direction of conveyance of the transport vehicle, the relative speed between the platform and the receiving part can be reduced, which facilitates loading/unloading of the receiving part.

### BRIEF DESCRIPTION OF THE DRAWINGS

In the following, the present teaching shall be described in greater detail with reference to FIGS. 1 to 3, which show exemplary, schematic, and non-limiting advantageous embodiments of the present teaching. In the drawings:

FIG. 1 is a cableway station of a cableway,

FIG. 2 is a cableway vehicle of a cableway, and

FIG. 3 is a transport vehicle of a cableway for transporting an object in a cableway station.

### DETAILED DESCRIPTION

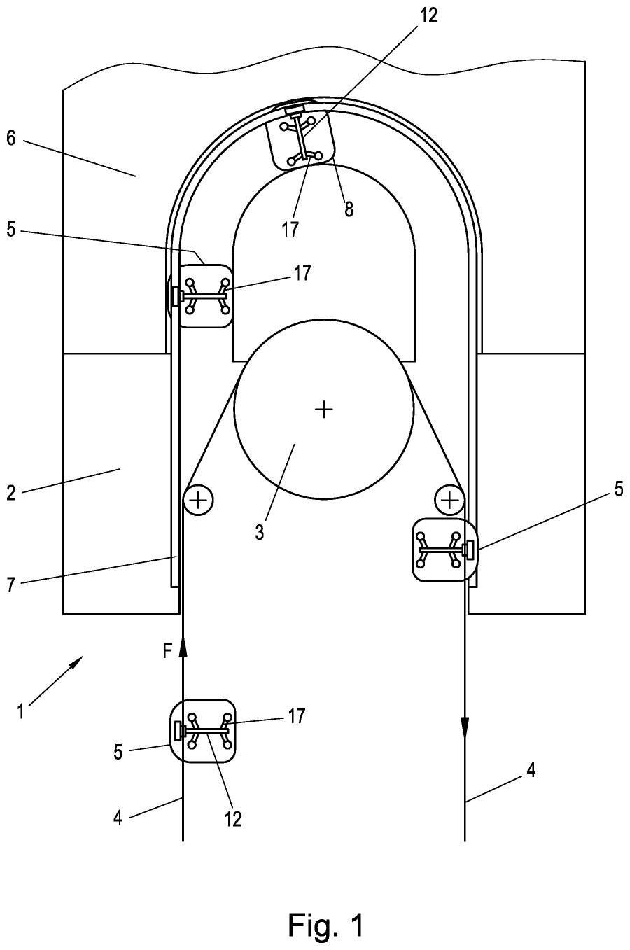

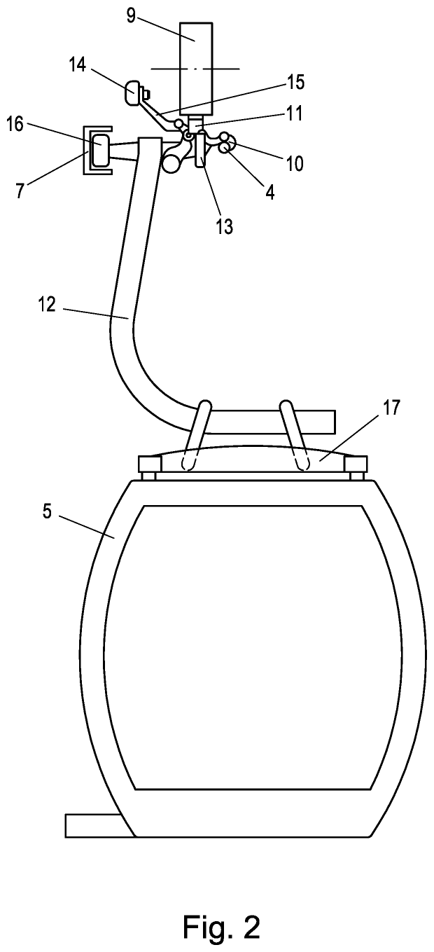

The design and function of a cableway system is well known, which is why it is only briefly explained with reference to FIGS. 1 and 2 using the example of a circulating gondola lift. FIG. 1 shows a cableway station 2 (for example, a top or bottom cableway station) of the cableway 1. A pulley wheel 3 which turns around a circulating haul rope 4 of the cableway 1 is arranged in the cableway station 2. A pulley wheel 3 in at least one of the stations of the cableway 1 is driven in a known manner by a drive, in order to allow the haul rope 4 to circulate in a loop around a pulley wheel of a further station. It is also known that the haul rope 4 is tensioned by a tensioning device acting on the pulley wheel 3. The cableway 1 is controlled by a cableway controller in the form of suitable hardware and software. For reasons of clarity and because they are irrelevant to the present teaching, these devices, which are known per se, in particular, the second station with the pulley wheel, drive, tensioning devices, cableway controller, etc., are not shown. A cableway 1 can of course move a very large number of cableway vehicles 5 simultaneously with the haul rope 4, typically in the range of a few tens or a few hundred cableway vehicles 5, whereas only a few of which are shown for the sake of simplicity. A platform 6 is also provided in the cableway station 2 in order to enable or facilitate the boarding and exit of persons to be transported.

If the cableway 1 is not equipped with cableway vehicles 5 that are permanently clamped to the haul rope 4, a cableway vehicle 5 of the cableway 1 entering the cableway station 2 is decoupled from the haul rope 4, usually by means of a releasable rope clamp 10 (FIG. 2), and moved along a guide rail 7 through the cableway station 2, usually at a significantly lower speed than in the portion of the travel between the cableway stations. A conveyor 8 is provided along the guide rail 7 be means of which the cableway vehicle 5 are moved through the cableway station 2. The conveyor 8 is designed, for example, in the form of driven conveyor wheels 9 which are arranged in the cableway station 2 and which work together with a friction lining 11 on the cableway vehicle 5 in the cableway station 2. When the cableway vehicle 5 exits the cableway station 2, the cableway vehicle 5 is accelerated via the conveyor 8 at the exit, and then coupled to the haul rope 4, for example by means of a rope clamp 10.

A cableway vehicle 5 of the cableway 1—in this case, a cable car—that can be decoupled from the haul rope 4, is shown in FIG. 2. The cableway vehicle 5 is arranged on a hanger 12 by means of a mounting 17. The cableway vehicle 5 can be connected via the hanger 12 to a carriage 13, for example consisting of at least one roller. A rope clamp 10 can be arranged on the hanger 12, which can clamp the haul rope 4 when a clamping spring acts on it, and which can be actuated mechanically via a coupling roller 14 and a clamp lever 15. The clamp lever 15 is actuated and the cable clamp 10 is opened when the coupling roller 14 follows a guide motion link in the cableway station 2. The rope clamp 10 is activated for the closing movement by a further guide motion link, and is kept closed by the action of the clamp spring. A guide roller 16 which interacts with the guide rail 7 in the cableway station 2 can also be arranged on the hanger 12. A friction lining 11 can also be provided, which can interact with the conveyor 8, for example the rotating conveyor wheels 9, in order to move the uncoupled cableway vehicle 5 along the guide rail 7 through the cableway station 2.

Of course, other configurations of a cableway 1 and/or a cableway vehicle 5 are also conceivable, for example a cableway 1 with cableway vehicles 5 permanently clamped to the haul rope 4, or with chairs instead of cable cars as the cableway vehicle 5, or with track ropes to which the cableway vehicle 5 is attached via a carriage moved by at least one haul rope 4. Likewise, the cableway 1 can be designed as reversible aerial tramway, with or without a track rope, that is, with a haul rope 4 which travels back and forth, rather than a circulating haul rope 4. However, the specific design of the cableway 1 is irrelevant to the present teaching.

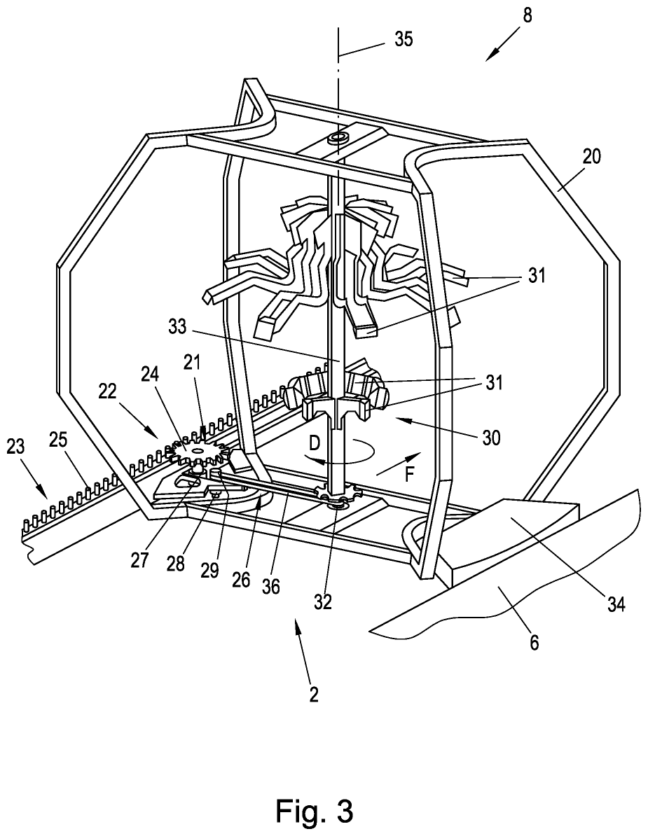

With the cableway 1, preferably a gondola lift with cable cars as the cableway vehicle 5, at least one transport vehicle 8 for objects is moved. The transport vehicle 8 is moved like a conventional cableway vehicle 5 by the haul rope 4 or, in the case of a decouplable transport vehicle 8 in the cableway station 2 by means of a conveyor 8. The transport vehicle 8 is explained in more detail with reference to FIG. 3 using an exemplary embodiment, wherein the mounting 17 and the hanger 12 are not shown, for reasons of clarity. The transport vehicle 8 is shown in a cableway station 2 in which the transport vehicle 8 is moved along a platform 6 for passengers. Passengers in the cableway station 2 can get on or off conventional cableway vehicles 5 via the platform 6.

The transport vehicle 8 comprises a frame 20 and a receiving part 30 which is arranged on the frame 20 and can be moved relative to the transport vehicle 8 and has a plurality of receiving members 31. The receiving part 30 is used for temporarily (in particular for transport from one cableway station 2 to another) and releasably receiving at least one object, such as a bicycle or other sports or leisure equipment. The frame 20 can also be completely or partially covered, such that the receiving part 30 is at least partially surrounded by the covering, and a door can also be provided on the transport vehicle 8, which opens and closes in a cableway station 2 in order to allow access to the receiving part 30 in the cableway station 2.

A vehicle component 21 of a drive gear mechanism 22 is rotatably mounted on the transport vehicle 8, preferably on the frame 20. The drive gear mechanism 22 is completed by a station component 23 arranged in the cableway station 2. The station component 23 and the vehicle component 21 interact to form a drive (as will be explained in detail below). As a result, the relative speed between the transport vehicle 8, with the vehicle component 21, and a portion of the cableway station 2 results in a drive which causes the vehicle component 21 on the transport vehicle 8 to rotate. The rotational speed is proportional to the relative speed, and depends on the gear ratio implemented by the drive gear mechanism 22.

The drive gear mechanism 22 drives the receiving part 30 arranged on the transport vehicle 8. On the receiving part 30, there is a plurality of receiving devices 31 for temporarily (in particular for transport from one cableway station 2 to another) and releasably receiving at least one object, for example a bicycle or other sports or leisure equipment. This drive drives the receiving part 30 of the transport vehicle 8 in a cableway station 2, and thus moves it relative to the transport vehicle 8. In particular, it rotates it relative to the transport vehicle 8. The drive is of course inactive outside a cableway station 2, because there is no station component 23 outside a cableway station, which means that the receiving part 30 also does not move relative to the transport vehicle 8 outside a cableway station 2.

The drive gear mechanism 22 can be designed as a non-positive gearing, for example with a friction wheel and a friction surface, or as a positive gearing, for example with teeth. In the case of a non-positive gearing, precautions are preferably taken to compensate for any transverse movement of the transport vehicle 8 when it passes through the cableway station 2, in order to prevent the drive from being disconnected. For this purpose, for example, a suitable pressing device for a friction wheel could be provided as the vehicle component 21. For example, the vehicle component 21 could be resiliently pressed against the station component 23. However, the weight of the transport vehicle 8 alone could also be sufficient to ensure adequate contact between the parts of a non-positive gearing. A change in the direction of travel of the transport vehicle 8 also results in a change in direction of the drive, and consequently also a change in the direction of movement of the receiving part 30.

The receiving part 30 is preferably rotatably arranged on the transport vehicle 8, and the drive is preferably designed in such a way that the receiving part 30 rotates completely at least once while the transport vehicle 8 is passing through the cableway station 2, such that each receiving device 31 on the receiving part 30 faces the platform 6 at least once. Each receiving device 31 is thus accessible at least once from the platform 6, and can be loaded with the object, and/or the object can be removed from the receiving part 30.

Depending on the design of the station component 23, a continuous movement of the receiving part 30 when the transport vehicle 8 passes through the cableway station 2 can be implemented, or a discontinuous movement can be implemented. If the station component 23 is only provided in sections, for example in the direction of conveyance F of the transport vehicle 8, the receiving part 30 is only driven in the sections which have a station component 23. In this way, a loading area and/or unloading area can be easily implemented in the cableway station 2.

Multiple loading and/or unloading areas can also be provided. For example, a station component 23 can be provided between loading or unloading areas which are arranged one after the other, in order to advance the receiving part 30 by one receiving device 31 between one loading or unloading area and the next, wherein no station component 23 is provided in the region of the loading or unloading area, and the receiving part 30 is therefore not moved in this area.

It can be advantageous if the drive gear mechanism 22 is designed in such a way that the direction of movement of the receiving part 30 is opposite to the direction of conveyance F of the transport vehicle 8 through the cableway station 2. The differential speed between the receiving part 30 (or a receiving device 31 thereof) and the platform 6 is thus lower, which can facilitate the loading or unloading of the receiving part 30.

The station component 23 is preferably arranged on the side of the cableway station 2 opposite the platform 6. The transport vehicle 8 is preferably guided through the cableway station 2 between the platform 6 and the station component 23.

In order to ensure trouble-free operation of the cableway 1, the station component 23 is of course arranged in the cableway station 2 in such a way that any cableway vehicles 5 without a vehicle component 21 do not collide with the station component 23.

In the exemplary embodiment according to FIG. 3, the drive gear mechanism 22 is designed as a positive gearing, with a gear wheel 24 as the vehicle component 21 on the transport vehicle 8, and with a toothed rail 25 as the station component 23 of the cableway station 2. Such a toothing has the advantage that certain transverse movements are permissible and possible, without loss of the engagement of the toothing. The toothed rail can be designed in the form of pins which are arranged one behind the other in the direction of conveyance F of the transport vehicle 8 through the cableway station 2, and into which the toothed wheel 24 on the transport vehicle 8 engages. However, the toothed rail 25 can also be designed as a toothed rack, or in the form of a chain. A chain as a toothed rail 25 is particularly advantageous, because it can be adapted to the shape of the cableway station 2 very easily.

The drive gear mechanism 22 causes substantially no transverse movement (transverse to the direction of conveyance F) of the transport vehicle 8. Likewise, no transverse movement of the vehicle component 21 is caused relative to the transport vehicle 8. Rather, the vehicle component 21 is preferably only rotated about its axis of rotation. The vehicle component 21 is also not designed as a lever that is pivoted by contact and that acts on a mechanism when pivoted. The station component 23 therefore has no gain in height in the transverse direction transverse to the direction of conveyance F, or in a vertical direction normal to the direction of conveyance, as would be necessary with a motion link used to pivot a lever via a contact element. A pure rotational movement of the vehicle component 21 about an axis of rotation is brought about by the drive gear mechanism 22.

With the drive gear mechanism 22, a transmission ratio between the speed at which the transport vehicle 8 travels through the cableway station 2 and the rotational speed or revolving speed of the receiving part 30 can also be achieved in a simple manner via the design of the drive components. A first transmission ratio results from the design of the drive gear mechanism 22 with the station component 23 and the vehicle component 21.

However, an additional transmission part 26 can also be provided between the vehicle component 21 and the receiving part 30 in order to achieve a desired transmission ratio between the rotational movement of the vehicle component 21 and the receiving part 30, in particular its rotational movement or revolving movement. The transmission part 26 thus produces an optional second transmission ratio. In this way, the relative speed between the receiving part 30 and the transport vehicle 8, for example a rotation speed, can be set or adjusted and substantially independently of the first transmission ratio of the drive gear mechanism 22. The transmission part 26 can be designed in any way, even with a plurality of transmission ratio stages. For example, one transmission ratio stage of the transmission part 26 could be designed as a gear drive, or as a traction drive with a drive belt (V-belt, toothed belt, flat belt, etc.), or as a chain drive with a drive chain. For the purpose of advancing the receiving part 30 in a stepwise fashion, versions with stepping gears as transmission ratio stage can also be contemplated. In addition, of course, other mechanical transmission ratio stages are also conceivable. A combination of differently designed transmission ratio stages is also possible.

In FIG. 3, for example, a first transmission ratio stage of the transmission part 26 is designed as a gear mechanism. For this purpose, the driven vehicle component 21 rotates a first gear wheel 27, which engages in a second gear wheel 28, which in turn drives a first belt pulley 29 of a traction drive as the second transmission ratio stage. A second belt pulley 32 drives the receiving part 30 via a drive belt 36.

Overload protection is preferably provided in the drive gear mechanism 22 and/or in a transmission part 26, or in another component of the drive of the receiving part 30, to prevent a person being clamped between the receiving part 30, a receiving device 31 or an object in a receiving device 31 and the transport vehicle 8. The overload protection is preferably implemented in such a way that a maximum specified clamping force is not exceeded. The overload protection is designed, for example, as a safety clutch for limiting the torque in the drive of the receiving part 30.

The receiving part 30 is, for example, a column 33 mounted on the transport vehicle 8 to allow rotation in the direction of rotation D, wherein the axis of rotation 35 of the receiving part 30 is preferably oriented perpendicular to the transport vehicle 8 and preferably substantially normal to the platform 6. However, the axis of rotation 35 could also be oriented differently, for example horizontally in the direction of conveyance F. A number of radially projecting receiving devices 31 are distributed over the circumference (seen in the direction of rotation D) on the column 30 in order to releasably arrange an object thereon, such as a bicycle or other sports or leisure equipment.

Depending on the object to be transported, the receiving devices 31 can of course be configured differently. Different receiving devices 31 for transporting different objects are also possible, for example half for bicycles and the other half for summer toboggans.

The term “releasable” in the context of the receiving device 31 means that the object can be placed in a receiving device 31 and/or can be removed therefrom, preferably manually, in a cableway station 2. A person can be transported by a cableway vehicle 5 of the cableway 1 arranged before or after it in the direction of conveyance F. The person can place the object on the receiving device 31 in a cableway station 2 (for example, in a lower station), and remove it in a further cableway station 2 (for example, in an upper station). However, the person can also be part of the service personnel of the cableway 1.

It can also be provided that only the receiving device 31 that is accessible directly from the platform 6 is unblocked, and the object can be removed therefrom or loaded therein. The other receiving devices 31 can be blocked, such that no item can be removed from them, or no item can be loaded onto them. The blocking and unblocking can also be coupled to the drive.

As the receiving part 30 with the number of receiving devices 31 is driven by the movement of the transport vehicle 8 passing through the cableway station 2 by the drive gear mechanism 22, and is thereby moved relative to the transport vehicle 8, various receiving devices 31 become accessible during the passage. They can be used for loading or removing objects in a simple manner.

The loading and unloading of the receiving devices 31 are preferably possible on the side of the transport vehicle 8 facing a platform 6 of the cableway station 2. For this purpose, a step platform 34 facing the platform 6 can also be provided on the transport vehicle 8, in order to facilitate access to the receiving part 30.

The speed of movement of the receiving part 30 is preferably selected in such a manner that the receiving part 30 performs at least one rotation when passing through the cableway station 2 in the area where people board or exit, or in the intended loading or unloading areas. It can thus be ensured that each receiving device 31 on the receiving part 30 in the cableway station 2 is accessible at least once.

Of course, the receiving part 30 can also be designed differently than a column 33. For example, a disk driven by the drive gear mechanism 22 could be rotatably mounted on the transport vehicle 8, with a plurality of receiving devices 31 distributed around its circumference. An upper and lower disk, which are connected by receiving devices 31, would also be conceivable. The receiving part 30 could also be implemented as a circulating belt driven by the drive gear mechanism 22 (in the manner of an endless conveyor belt), with receiving devices 31 attached thereto. In this case, the drive would be used to adjust the revolving speed of the belt.

The station component 23 is preferably arranged in a stationary manner in the cableway station 2. However, it is also conceivable that the station component 23 is movably arranged in the cableway station 2, preferably movable in the direction of conveyance F. Such a movable station component 23 of the drive gear mechanism 22 could also be used to influence the relative speed of the receiving part 30 relative to the transport vehicle 8.

For example, the station component 23 could be designed as a toothed belt circulating in the station 2, or as a circulating chain. The relative speed between the station component 23 and the vehicle component 21 could then be influenced by the revolving speed of the station component 23.

Instead of the drive gear mechanism 22 according to the present teaching, with a station component 23 and a vehicle component 21, an electric drive could also be provided for driving the receiving part 30 on the transport vehicle 8. In this case, however, an electrical supply would be required on the transport vehicle 8.

1. A cableway station through which a transport vehicle for receiving an object to be transported can be moved,
wherein a receiving part with a plurality of receiving devices for releasably receiving an object is arranged on the transport vehicle, wherein the receiving part is movable relative to the transport vehicle,
wherein a vehicle component is rotatably mounted on the transport vehicle, and the vehicle component, drives the movement of the receiving part, and
a station component is arranged on the cableway station, said station component, is designed to interact with the vehicle component rotatably mounted on the transport vehicle to form a drive gear mechanism, wherein the station component extends at least in sections along the cableway station in the direction of conveyance of the transport vehicle through the cableway station.

2. The cableway station according to claim 1, wherein the receiving part is arranged in a manner allowing rotation relative to the transport vehicle.

3. The cableway station according to claim 1, wherein a transmission part is provided between the vehicle component and the receiving part with at least one transmission ratio stage in order to set a transmission ratio between the rotational movement of the vehicle component and the movement of the receiving part.

4. The cableway station according to claim 3, wherein the transmission par is designed with a first transmission ratio stage having a gear mechanism, and a second transmission ratio stage having a traction drive or chain drive.

5. The cableway station according to claim 1, wherein the vehicle component is designed as a friction wheel and the station component is designed as a friction surface for a non-positive drive gear mechanism, or the vehicle component is designed as a gear wheel, and the station component is designed as a toothed rack, chain, or with pins for a positive drive gear mechanism.

6. The cableway station according to claim 1, wherein the receiving part is designed as a column rotatably mounted on the transport vehicle, and the receiving devices are arranged on the column.

7. The cableway station according to claim 1, wherein a platform is provided in the cableway station, and the station component is arranged opposite the platform, such that the transport vehicle can be moved between the platform and the station component.

8. The cableway station according to claim 1, wherein at least one region with a station component and one adjoining region without a station component are provided along the cableway station.

9. The cableway station according to claim 1, wherein several consecutive regions with station components and without station components are provided along the cableway station.

10. The cableway station according to claim 1, wherein the station component is arranged stationary on the cableway station.

11. The cableway station according to claim 1, wherein the station component is arranged on the cableway station to be movable in the direction of conveyance of the transport vehicle.

12. A cableway having
at least two cableway stations and having a haul rope which moves at least one transport vehicle for an object to be conveyed with the cableway between the cableway stations,
a vehicle component of a drive gear mechanism is rotatably mounted on the transport vehicle, and
a station component is arranged in at least one cableway station, said station component interacts at least temporarily with the vehicle component to form a drive gear mechanism when the transport vehicle passes through the cableway station in a direction of conveyance, and
a receiving part having a plurality of receiving devices for releasably receiving the object is arranged on the transport vehicle, wherein the receiving part is movable relative to the transport vehicle, and the movement thereof is driven by the vehicle component of the drive gear mechanism.

13. The cableway according to claim 12, wherein the direction of movement of the receiving part is opposite the direction of conveyance.

14. The cableway according to claim 12, wherein the drive gear mechanism is designed to completely rotate the receiving part at least once when it passes through the cableway station.
